(19) United States
(12) Patent Application Publication
(10) Pub. No.: US 2018/0287140 A1
(43) Pub. Date: Oct. 4, 2018

(54) NEGATIVE ELECTRODE ACTIVE MATERIAL FOR NONAQUEOUS ELECTROLYTE SECONDARY BATTERIES AND NEGATIVE ELECTRODE

(71) Applicant: Panasonic Intellectual Property Management Co., Ltd., Osaka-shi, Osaka (JP)

(72) Inventors: Tatsuya Akira, Osaka (JP); Taizou Sunano, Tokushima (JP); Hiroshi Minami, Hyogo (JP)

(73) Assignee: Panasonic Intellectual Property Management Co., Ltd., Osaka-shi, Osaka (JP)

(21) Appl. No.: 15/753,797

(22) PCT Filed: Aug. 23, 2016
(86) PCT No.: PCT/JP2016/003817

§ 371 Date: Feb. 20, 2018

(30) Foreign Application Priority Data
Sep. 24, 2015 (JP) 2015-187330

(51) Int. Cl. H01M 4/36; H01M 4/38; H01M 4/131; H01M 10/052

(52) U.S. Cl. CPC H01M 4/364; H01M 4/386; H01M 2004/021; H01M 10/052; H01M 4/131

(57) ABSTRACT

Negative electrode active material particles each include a composite particle containing silicon particles and a lithium silicate phase represented by LiₓSiO_{y} (0<x≤4, and 0<y≤4); and a surface layer provided on the surface of the composite particle, and the surface layer contains a silane coupling agent.

### TECHNICAL FIELD

The present disclosure relates to a negative electrode active material for nonaqueous electrolyte secondary batteries and a negative electrode.

### BACKGROUND ART

A silicon material, such as silicon (Si) or a silicon oxide represented by SiOₓ, has been known to occlude a large amount of lithium ions per unit volume as compared to that of a carbon material, such as graphite, and application of the silicon material to a negative electrode of lithium ion batteries and the like has been studied.

A nonaqueous electrolyte secondary battery which uses a silicon material as a negative electrode active material has a problem in that a charge/discharge efficiency is low as compared to that in the case in which graphite is used as a negative electrode active material. Hence, in order to improve the charge/discharge efficiency, the use of a lithium silicate represented by LiₓSiO_{y} (0<x<1.0, and 0<y<1.5) as a negative electrode active material has been proposed (see Patent Document 1).

In addition, in Patent Document 2, a negative electrode active material in which silicon is surface-treated with a silane coupling agent has been proposed, and in Patent Document 3, a negative electrode active material containing a carbon material, a metal oxide, and a silane coupling agent which forms a network structure with the metal oxide has been proposed.

### CITATION LIST

### Patent Document

Patent Document 1: Japanese Published Unexamined Patent Application No. 2003-160328

Patent Document 2: Japanese Published Unexamined Patent Application No. 2014-150068

Patent Document 3: Japanese Published Unexamined Patent Application No. 2011-249339

### SUMMARY OF INVENTION

### Technical Problem

Incidentally, in view of increase in capacity and the like, the use of a negative electrode active material containing silicon and a lithium silicate may be conceived; however, since silicon has a high reactivity with an electrolyte liquid, a decrease in capacity in association with charge/discharge cycles may cause a problem. In addition, when a negative electrode is famed by using a negative electrode slurry in which the negative electrode active material as described above is dispersed in an aqueous medium, such as water, a problem in that a gas is generated from the negative electrode slurry may also arise.

The present disclosure provides a negative electrode active material for nonaqueous electrolyte secondary batteries, the negative electrode active material using silicon and a lithium silicate and being able to suppress a decrease in capacity in association with charge/discharge cycles, and also provides a negative electrode including the negative electrode active material described above.

### Solution to Problem

A negative electrode active material for nonaqueous electrolyte secondary batteries according to one aspect of the present disclosure comprises composite particles each containing silicon and a lithium silicate represented by LiₓSiO_{y} (0<x≤4, and 0<y≤4); and surface layers provided on the surfaces of the composite particles, and the surface layers each contain a silane coupling agent.

### Advantageous Effects of Invention

According to the one aspect of the present disclosure, in the negative electrode active material using silicon and a lithium silicate, a decrease in capacity in association with charge/discharge cycles can be suppressed.

### BRIEF DESCRIPTION OF DRAWINGS

FIG. 1 is a cross-sectional view schematically showing a negative electrode active material particle which is one example of an embodiment.

FIG. 2 is a view showing one example of a silane coupling agent bonded to silicon.

### DESCRIPTION OF EMBODIMENT

Hereinafter, one example of an embodiment will be described in detail. The drawings to be used for illustration of the embodiment are schematically drawn, and for example, the dimensional ratio of each constituent element shown in the drawings may be different from the actual dimensional ratio in some cases. In addition, particular dimensional ratios and the like are to be appropriately understood in consideration of the following description.

In a negative electrode active material according to one aspect of the present disclosure, a surface layer containing a silane coupling agent is provided entirely or partially on the surface of a composite particle containing silicon and a lithium silicate represented by LiₓSiO_{y} (0<x≤4, and 0<y≤4). In addition, according to the negative electrode active material of the one aspect of the present disclosure, for example, since Si having a reactivity with an electrolyte liquid (nonaqueous electrolyte) is protected by the surface layer containing a silane coupling agent, a reaction between Si and the electrolyte liquid is suppressed, and a decrease in capacity in association with charge/discharge cycles can be suppressed.

In addition, in order to form a negative electrode, when composite particles each containing silicon and a lithium silicate and an aqueous medium, such as water, are mixed together to form a negative electrode slurry, in general, the lithium silicate in the composite particle is partially dissolved, and alkalinity is shown. In addition, water (OH⁻+H₂O) containing an alkali derived from the lithium silicate thus dissolved and the silicon (Si) in the composite particle react with each other, so that gas generation occurs. The reaction between silicon and water containing an alkali is represented, for example, by the following formula.

Si+2OH⁻+2H₂O→SiO₂(OH)²⁻+2H₂

In the negative electrode active material according to the one aspect of the present disclosure, by the surface layer containing a silane coupling agent entirely or partially provided on the surface of the composite particle, the dissolution of the lithium silicate and the reaction between silicon and water containing an alkali derived from the lithium silicate thus dissolved are suppressed, so that the gas generation can be suppressed. In addition, since the surface layer containing a silane coupling agent is likely to be formed on silicon present at the surface of the composite particle as compared to on a lithium silicate present at the surface of the composite particle, it is believed that an effect of suppressing the reaction between silicon and water containing an alkali derived from the lithium silicate thus dissolved is higher than an effect of suppressing the dissolution of the lithium silicate. In addition, for example, since the reaction between silicon and water containing an alkali derived from the lithium silicate thus dissolved is suppressed, etching of the silicon is suppressed, and the formation of a new silicon surface (newly-formed surface) to be brought into contact with the electrolyte liquid is suppressed; hence, it is believed that the decrease in capacity in association with charge/discharge cycles can be suppressed. In addition, since the gas generation is suppressed, it is believed that for example, the slurry may be stored for a long period of time.

In addition, in a negative electrode active material according to another aspect of the present disclosure, a silane coupling agent forming a surface layer has an amino group. Since the silane coupling agent having an amino group is believed to be stable in water containing an alkali derived from a lithium silicate as compared to, for example, a silane coupling agent having an epoxy group, the gas generation is further suppressed, the formation of a newly-famed surface of silicon is further suppressed, and the decrease in capacity in association with charge/discharge cycles is further suppressed.

Hereinafter, a nonaqueous electrolyte secondary battery using the negative electrode active material according to the one aspect of the present disclosure will be described.

A nonaqueous electrolyte secondary battery according to one example of the embodiment comprises a negative electrode containing the negative electrode active material described above, a positive electrode, and a nonaqueous electrolyte containing a nonaqueous solvent. Between the positive electrode and the negative electrode, at least one separator is preferably provided. As one example of the structure of the nonaqueous electrolyte secondary battery, the structure in which an electrode body famed by winding a positive electrode and a negative electrode with at least one separator provided therebetween and a nonaqueous electrolyte are received in an exterior package may be mentioned. Alternatively, instead of using a wound type electrode body, another electrode body, such as a laminate type electrode body in which at least one positive electrode and at least one negative electrode are laminated with at least one separator provided therebetween may also be used. The nonaqueous electrolyte secondary battery may have, for example, any shape, such as a cylindrical shape, a square shape, a coin shape, a bottom shape, or a laminate shape.

[Positive Electrode]

The positive electrode is preferably formed, for example, from a positive electrode collector formed of metal foil or the like and at least one positive electrode mixture layer famed on the collector. For the positive electrode collector, for example, foil formed from a metal, such as aluminum, stable in a positive electrode potential range or a film on which the metal mentioned above is disposed as a surface layer may be used. The positive electrode mixture layer preferably contains besides the positive electrode active material, an electrically conductive material, a binding material, and the like. In addition, the particle surface of the positive electrode active material may be covered with fine particles of an inorganic compound including at least one of an oxide, such as an aluminum oxide (Al₂O₃), a phosphoric acid compound, a boric acid compound, and the like.

As the positive electrode active material, a lithium transition metal oxide containing a transition metal element, such as Co, Mn, or Ni may be mentioned by way of example. As the lithium transition metal oxide, for example, there may be mentioned LiₓCoO₂, LiₓNiO₂, LiₓMnO₂, LiₓCo_{y}Ni_{1-y}O₂, LiₓCo_{y}M_{1-y}O_{z}, LiₓNi_{1-y}M_{y}O_{z}, LiₓMn₂O₄, LiₓMn_{2-y}M_{y}O₄, LiMPO₄, or Li₂MPO₄F (M: at least one selected from Na, Mg, Sc, Y, Mn, Fe, Co, Ni, Cu, Zn, Al, Cr, Pb, Sb, and B; 0<x≤1.2, 0<y≤0.9, and 2.0≤z≤2.3 hold). Those materials may be used alone, or at least two types thereof may be used by mixing.

The electrically conductive material is used, for example, to increase the electrical conductivity of the positive electrode mixture layer. As the electrically conductive material, a carbon material, such as carbon black, acetylene black, Ketjen black, or graphite, may be mentioned by way of example. Those materials may be used alone, or at least two types thereof may be used in combination.

The binding material is used to maintain a preferable contact state, for example, between the positive electrode active material and the electrically conductive material and also to enhance a binding property of the positive electrode active material or the like to the surface of the positive electrode collector. As the binding material, for example, there may be mentioned a fluorine-containing resin, such as a polytetrafluoroethylene (PTFE) or a poly(vinylidene fluoride) (PVdF), a polyacrylonitrile (PAN), a polyimide-based resin, an acrylic resin, a polyolefin-based resin, or the like. In addition, together with at least one of the resins mentioned above, for example, a carboxymethyl cellulose (CMC) or its salt (such as CMC-Na, CMC-K, CMC-NH₄, or a partially neutralized type salt), or a poly(ethylene oxide) (PEO) may also be used. Those materials may be used alone, or at least two types thereof may be used in combination.

[Negative Electrode]

The negative electrode is preferably formed, for example, from a negative electrode collector famed of metal foil or the like and at least one negative electrode mixture layer formed on the collector. For the negative electrode collector, for example, foil of a metal, such as copper, stable in a negative electrode potential range or a film on which the metal mentioned above is disposed as a surface layer may be used. The negative electrode mixture layer preferably contains, besides the negative electrode active material, a binding material and the like. As the binding material, as is the case of the positive electrode, for example, a fluorine-containing resin, a PAN, a polyimide-based resin, an acrylic resin, or a polyolefin-based resin may be used. When a mixture material slurry is prepared using an aqueous solvent, for example, a CMC or its salt (such as CMC-Na, CMC-K, CMC-NH₄, or a partially neutralized type salt), a styrene-butadiene rubber (SBR), a poly(acrylic acid) (PAA) or its salt (such as PAA-Na, PAA-K, or a partially neutralized type salt), or a poly(vinyl alcohol) (PVA) is preferably used.

The negative electrode active material comprises composite particles each containing silicon and a lithium silicate represented by LiₓSiO_{y} (0<x≤4, and 0<y≤4) and surface layers which are provided on the surfaces of the composite particles and which contain a silane coupling agent. In this case, the composite particle indicates a particle in which a lithium silicate component and a silicon component are dispersed along the surface of the composite particle and in the bulk thereof. For example, a composite particle containing a lithium silicate phase represented by LiₓSiO_{y} (0<x≤4, and 0<y≤4) and silicon particles dispersed in the lithium silicate phase may be mentioned. The lithium silicate phase is an aggregate of lithium silicate particles. Alternatively, for example, there may be mentioned a composite particle containing a silicon phase and lithium silicate particles which are dispersed in the silicon phase and which are represented by LiₓSiO_{y} (0<x≤4, and 0<y≤4). The silicon phase is an aggregate of silicon particles.

Hereinafter, with reference to the drawings, although the negative electrode active material of the present disclosure will be described in more detail, as the composite particles, composite particles each containing a lithium silicate phase and silicon particles dispersed in the lithium silicate phase will be described by way of example. However, the composite particles of the present disclosure are not limited to the composite particles each containing a lithium silicate phase and silicon particles dispersed in the lithium silicate phase and may be composite particles each containing a silicon phase and lithium silicate particles dispersed in the silicon phase, a mixture formed by mixing those composite particles described above, or the like.

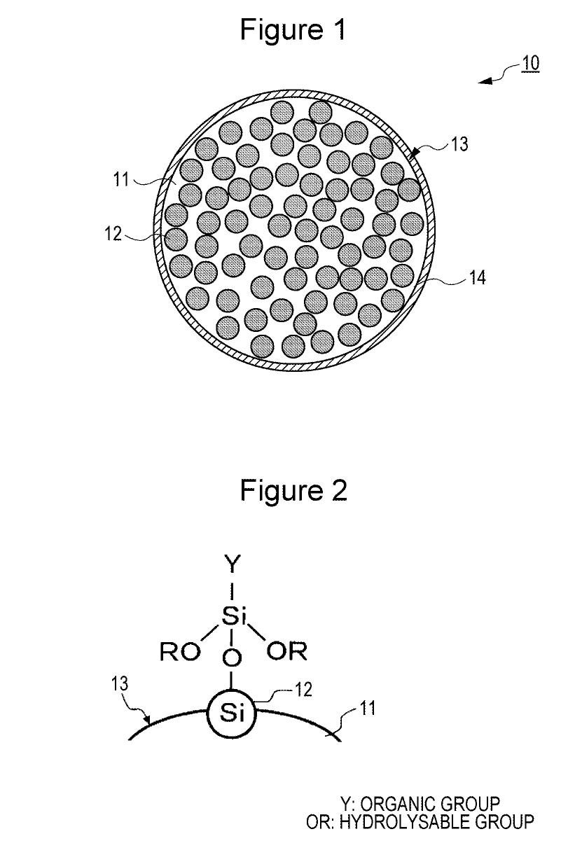

In FIG. 1, a cross-sectional view of a negative electrode active material particle which is one example of the embodiment is shown. A negative electrode active material particle 10 shown in FIG. 1 by way of example includes a composite particle 13 containing a lithium silicate phase 11 represented by LiₓSiO_{y} (0<x≤4, and 0<y≤4) and silicon particles 12 dispersed in the phase described above. That is, the composite particle 13 shown in FIG. 1 has a sea-island structure in which the fine silicone particles 12 are dispersed in the lithium silicate phase 11. At an arbitrary cross-section of the composite particle 13, the silicon particles 12 are preferably approximately uniformly dispersed without being localized in a limited region. Since the composite particle 13 shown in FIG. 1 has a particle structure in which the silicon particles 12 each having a small particle diameter are dispersed in the lithium silicate phase 11, the change in volume of silicon in association with charge/discharge is suppressed, and the particle structure is preferably suppressed from being collapsed.

In addition, the negative electrode active material particle 10 shown in FIG. 1 by way of example includes a surface layer 14 formed on the surface of the composite particle 13 which is formed from the lithium silicate phase 11 and the silicon particles 12, and the surface layer 14 contains a silane coupling agent. In the negative electrode active material particle 10 shown in FIG. 1 by way of example, although the surface layer 14 is famed on the entire surface of the composite particle 13, the surface layer 14 may be formed on part of the surface of the composite particle 13. Whether the surface layer 14 containing a silane coupling agent is formed on the surface of the composite particle 13 or not may be confirmed, for example, by a Raman spectral analysis.

The silane coupling agent forming the surface layer 14 is an organic silicone compound having an organic functional group and a hydrolysable group in its molecule. As the hydrolysable group, for example, although a methoxy group, an ethoxy group, a halogen group, such as chlorine, or the like may be mentioned, the hydrolysable group is not limited thereto. As the organic functional group, for example, although an amino group, a vinyl group, an epoxy group, a methacrylic group, a mercapto group, or the like may be mentioned, the organic functional group is not limited thereto.

In FIG. 2, one example of the silane coupling agent bonded to silicon is shown. As shown in FIG. 2, it is believed that the hydrolysable group of the silane coupling agent is bonded to a silicon component present at the surface of the composite particle 13 to form the surface layer 14. In addition, although the silane coupling agent is believed to be also boned to the lithium silicate component, since the silane coupling agent is likely to be bonded to the silicon component as compared to the lithium silicate component, it is believed that the surface layer 14 is likely to be famed on the silicon particle 12 present at the surface of the composite particle 13.

By the surface layer 14 containing the silane coupling agent as described above, since the silicon particle 12 having a reactivity with an electrolyte liquid (nonaqueous electrolyte) is protected, the reaction between the silicon particles 12 and the electrolyte liquid is suppressed, and the decrease in capacity in association with charge/discharge cycles is suppressed. In addition, in a negative electrode slurry state for the formation of the negative electrode, since gas generation by a reaction between the silicon particles 12 and water containing an alkali primarily derived from the dissolved lithium silicate phase 11 can be suppressed, etching of the silicon particles 12 is suppressed, and the formation of a new silicon surface (newly-formed surface) to be brought into contact with the electrolyte liquid is suppressed. As a result, the decrease in capacity in association with charge/discharge cycles can be suppressed, or the negative electrode slurry can be stored for a long period of time.

Among the above organic functional groups shown by way of example, an amino group stable in alkaline water is preferable. That is, since the surface layer 14 contains a silane coupling agent having an amino group, in a slurry state for the formation of the negative electrode, the gas generation by the reaction between silicon and water containing an alkali derived from a dissolved lithium silicate can be efficiently suppressed. As a result, the formation of a new silicon surface (newly-formed surface) to be brought into contact with the electrolyte liquid is suppressed, the decrease in capacity in association with charge/discharge cycles can be further suppressed, or the negative electrode slurry can be stored for a longer period of time.

The content of the silane coupling agent with respect to the composite particle 13 is preferably in a range of 0.01 to 10 percent by mass and more preferably in a range of 0.5 to 2 percent by mass. When the content of the silane coupling agent is less than 0.01 percent by mass, the composite particle 13 cannot be sufficiently covered with the surface layer 14, and the decrease in capacity in association with charge/discharge cycles may not be effectively suppressed in some cases. In addition, when the content of the silane coupling agent is more than 10 percent by mass, the thickness of the surface layer 14 is excessively increased, the electrical conductivity of the negative electrode active material particle 10 is decreased, and the decrease in capacity may be caused thereby in some cases. The thickness of the surface layer 14 is, for example, preferably 1 to 200 nm and more preferably 5 to 100 nm.

The lithium silicate phase 11 contains a lithium silicate represented by LiₓSiO_{y} (0<x≤4, and 0<y≤4). Although the lithium silicate is dissolved in water by a reaction therewith as described above, for example, in order to suppress the reaction with water, a lithium silicate represented by Li_{2z}SiO_{(2+z)} (0<z<2) is preferable, and for example, Li₂SiO₃ (Z=1) or Li₂Si₂O₅ (Z=½) is preferably used as a primary component. When Li₂SiO₃ or Li₂Si₂O₅ is used as a primary component (component having the largest mass), the content of the primary component with respect to the total mass of the lithium silicate phase 11 is preferably more than 50 percent by mass and more preferably 80 percent by mass or more.

For example, in order to suppress the change in volume of the silicon particles 12 in association with charge/discharge, the lithium silicate phase 11 is preferably formed, for example, from fine particles smaller than the silicon particles 12. In an XRD pattern of the negative electrode active material particle 10, for example, the intensity of the diffraction peak of the (111) plane of Si is larger than the intensity of the diffraction peak of the (111) plane of the lithium silicate.

Since capable of occluding a large amount of lithium ions as compared to that of a carbon material, such as graphite, the silicon particle 12 is believed to contribute to an increase in capacity of a battery. In view of an increase in capacity, an improvement in cycle characteristics, and the like, the content of the silicon particles 12 in the composite particle 13 with respect to the total mass of the composite particle 13 is preferably 20 to 95 percent by mass and more preferably 35 to 75 percent by mass. When the content of the silicon particles 12 is excessively low, for example, the charge/discharge capacity is decreased, and in addition, load characteristics may be degraded in some cases by insufficient diffusion of lithium ions. When the content of Si is excessively high, for example, Si is partially exposed since not being covered with the lithium silicate and is brought into contact with the electrolyte liquid, and the cycle characteristics may be degraded in some cases.

For example, in order to suppress the change in volume in association with charge/discharge and to suppress the electrode structure from being collapsed, the average particle diameter of the silicon particles 12 is, for example, preferably in a range of 1 to 1,000 nm and more preferably in a range of 1 to 100 nm. On the other hand, for example, in consideration of the degree of easiness of manufacturing the composite particle 13, the average particle diameter of the silicon particles 12 is preferably in a range of 200 to 500 nm. The average particle diameter of the silicon particles 12 can be measured by observing the cross-section of the negative electrode active material particle 10 using a scanning electron microscope (SEM) or a transmission electron microscope (TEM) and, in particular, can be obtained by averaging the longest diameters of 100 silicon particles 12.

In an XRD pattern of the composite particle 13 obtained by XRD measurement, the half width of the diffraction peak of the (111) plane of the lithium silicate is preferably 0.05° or more. When the half width is adjusted to 0.05° or more, it is believed that the crystallinity of the lithium silicate phase 11 is decreased, the ion conductivity of lithium ions in the particle is improved, and the change in volume of the silicon particles 12 in association with charge/discharge can be further suppressed. Although a preferable half width of the diffraction peak of the (111) plane of the lithium silicate is slightly changed depending on the component of the lithium silicate phase 11, the half width is more preferably 0.09° or more, such as 0.09° to 0.55°.

Measurement of the half width of the diffraction peak of the (111) plane of the lithium silicate is performed under the following conditions. When a plurality of lithium silicates is contained, the half width (° (2θ)) of the peak of the (111) plane of every lithium silicate is measured. In addition, when the diffraction peak of the (111) plane of the lithium silicate is overlapped with a diffraction peak of another plane index or a diffraction peak of another material, the diffraction peak of the (111) plane of the lithium silicate is separated, and the half width thereof is measured.

Measurement apparatus: X-ray diffraction measurement apparatus (Type RINT-TTRII), manufactured by Rigaku Corporation.

Anticathode: Cu

Tube voltage: 50 kV

Tube current: 300 mA

Optical system: parallel beam method

[Incident side: multilayer film mirror (divergence angle: 0.05°, beam width: 1 mm), soller slit (5°); Light-receiving side: long slit PSA200 (resolution: 0.057°), soller slit (5°)]

Scanning step: 0.01° or 0.02°

Counting time: 1 to 6 seconds

When the lithium silicate phase 11 contains Li₂Si₂O₅ as a primary component, the half width of the diffraction peak of the (111) plane of Li₂Si₂O₅ in the XRD pattern of the negative electrode active material particle 10 is preferably 0.09° or more. For example, when the content of Li₂Si₂O₅ with respect to the total mass of the lithium silicate phase 11 is 80 percent by mass or more, one example of a preferable half width of the diffraction peak is 0.09° to 0.55°. In addition, when the lithium silicate phase 11 contains Li₂SiO₃ as a primary component, the half width of the diffraction peak of the (111) plane of Li₂SiO₃ in the XRD pattern of the negative electrode active material particle 10 is preferably 0.10° or more. For example, when the content of Li₂SiO₃ with respect to the total mass of the lithium silicate phase 11 is 80 percent by mass or more, one example of a preferable half width of the diffraction peak is 0.10° to 0.55°.

In order to increase the capacity, to improve the cycle characteristics, and the like, the average particle diameter of the negative electrode active material particles 10 is preferably 1 to 15 μm and more preferably 4 to 10 μm. in this case, the average particle diameter of the negative electrode active material particles 10 is obtained from particle diameters of primary particles and indicates a particle diameter (volume average particle diameter) at which the volume accumulated value is 50% in a particle size distribution measured by a laser diffraction scattering method (for example, by “LA-750” manufactured by HORIBA, Ltd.). When the average particle diameter of the negative electrode active material particles 10 is excessively small, since the surface area is increased, a reaction amount with the electrolyte is increased, and the capacity tends to be decreased. On the other hand, when the average particle diameter is excessively large, since the change in volume caused by charge/discharge is increased, the cycle characteristics tend to be degraded.

As the negative electrode active material, the negative electrode active material particles 10 may only be used, or at least one of other active materials which have been known in the past may also be used together therewith. As the other active materials, for example, since the change in volume in association with charge/discharge is small as compared to that of silicon, carbon materials, such as graphite, are preferable. As the carbon materials, for example, there may be mentioned natural graphite, such as flake graphite, massive graphite, or earthy graphite; artificial graphite, such as massive artificial graphite (MAG), or graphitized mesophase carbon microbeads (MCMB); and the like. The mass ratio of the negative electrode active material particles 10 to the carbon material is preferably 1:99 to 30:70. When the mass ratio of the negative electrode active material particles 10 to the carbon material is in the range described above, the increase in capacity and the improvement in cycle characteristics are likely to be simultaneously obtained.

The composite particles 13 are formed, for example, through the following steps 1 to 3. The following steps are each performed in an inert atmosphere.

(1) A mixture is formed by mixing a Si powder and a lithium silicate powder, each of which is pulverized to have an average particle diameter of approximately several to several tens of micrometers, for example, at a mass ratio of 20:80 to 95:5.

(2) Next, the mixture described above is pulverized into fine particles using a ball mill. Alternatively, after raw material powders are each formed into fine particles, a mixture may be formed therefrom.

(3) The mixture thus pulverized is heat-treated, for example, at 600° C. to 1,000° C. In this heat treatment, a sintered body of the above mixture may be formed by applying a pressure using a hot press or the like. In addition, without using a ball mill, the Si powder and the lithium silicate powder may be mixed together and then heat-treated.

As a method for forming the surface layer 14 containing a silane coupling agent on the surface of the composite particle 13, for example, a method in which the composite particles 13 and the silane coupling agent are mixed together, for example, at a mass ratio of 100:0.01 to 100:10 may be mentioned. Although the mixture thus obtained is preferably dried, a drying temperature is preferably set so that the structure of the silane coupling agent is not destroyed and no oxidation reaction of Si occurs and is also preferably set, for example, in a range of from room temperature to 150° C.

For example, after the surface layer 14 containing a silane coupling agent is formed on the surface of the composite particle 13 by the method described above, the particles thus prepared are mixed as a negative electrode active material with an aqueous solvent, such as water, to form a negative electrode slurry, and this slurry is applied to a collector to form a negative electrode. To the negative electrode slurry, if necessary, an electrically conductive agent, a binding agent, and the like may be added.

As another method for forming the surface layer 14 containing a silane coupling agent on the surface of the composite particle 13, for example, there may be mentioned a method in which a silane coupling agent is added to and mixed with a negative electrode slurry containing the composite particles 13 and an aqueous solvent, such as water, together with, if necessary, an electrically conductive agent, a binding agent, and the like. In addition, although the negative electrode slurry thus obtained is preferably heated, as is the case described above, a heating temperature is preferably set in a range of from room temperature to 150° C. In addition, the method for forming the surface layer 14 containing a silane coupling agent on the surface of the composite particle 13 is not limited to the methods described above.

The silane coupling agent to be used in the methods described above may be, for example, either an undiluted solution or a solution prepared using water, an alcohol, and/or the like. As the silane coupling agent, for example, there may be mentioned vinyltrichlorosilane, vinyltrimethoxysilane, vinyltriethoxysilane, β-(3,4 epoxyhexyl)ethyltrimethoxysilane, γ-glycidoxypropyltrimethoxysilane, γ-glycidoxypropylmethyldiethoxysilane, γ-glycidoxypropyltriethoxysilane, γ-methacryloxypropylmethyldiethoxysilane, γ-methacryloxypropyltrimethoxysilane, γ-methacryloxypropylmethyldiethoxysilane, γ-methacryloxypropyltriethoxysilane, γ-acryloxypropyltrimethoxysilane, N-(β-aminoethyl)-γ-aminopropylmethyldiethoxysilane, N-(β-aminoethyl)-γ-aminopropyltrimethoxysilane, N-(β-aminoethyl)-γ-aminopropyltriethoxysilane, γ-aminopropyltrimethoxysilane, γ-aminopropyltriethoxysilane, N-phenyl-γ-aminopropyltrimethoxysilane, γ-mercaptopropyltrimethoxysilane, γ-chloropropyltrimethoxysilane, or γ-ureidopropyltriethoxysilane; however, the silane coupling agent is not limited thereto.

[Nonaqueous Electrolyte]

The nonaqueous electrolyte contains a nonaqueous solvent and an electrolyte salt dissolved in the nonaqueous solvent. The nonaqueous electrolyte is not limited to a liquid electrolyte (nonaqueous electrolyte liquid) and may be a solid electrolyte using a gel polymer or the like. As the nonaqueous solvent, for example, an ester, an ether, a nitrile, such as acetonitrile, an amide, such as dimethylformamide, a mixed solvent containing at least two of the solvents mentioned above, or the like may be used. The nonaqueous solvent may include a halogen substituted compound in which at least one hydrogen atom of one of the solvents mentioned above is substituted by a halogen atom, such as fluorine.

As an example of the ester described above, for example, there may be mentioned a cyclic carbonate ester, such as ethylene carbonate (EC), propylene carbonate (PC), or butylene carbonate; a chain carbonate ester, such as dimethyl carbonate (DMC), methyl ethyl carbonate (EMC), diethyl carbonate (DEC), methyl propyl carbonate, ethyl propyl carbonate, or methyl isopropyl carbonate; a cyclic carboxylic acid ester, such as γ-butyrolactone (GBL) or γ-valerolactone (GVL); or a chain carboxylic acid ester, such as methyl acetate, ethyl acetate, propyl acetate, methyl propionate (MP), ethyl propionate, or γ-butyrolactone.

As an example of the ether described above, for example, there may be mentioned a cyclic ether, such as 1,3-dioxolane, 4-methyl-1,3-dioxolane, tetrahydrofuran, 2-methyltetrahydrofuran, propylene oxide, 1,2-butylene oxide, 1,3-dioxane, 1,4-dioxane, 1,3,5-trioxane, furan, 2-methylfuran, 1,8-cineole, or a crown ether; or a chain ether, such as 1,2-dimethoxyethane, diethyl ether, dipropyl ether, diisopropyl ether, dibutyl ether, dihexyl ether, ethyl vinyl ether, butyl vinyl ether, methyl phenyl ether, ethyl phenyl ether, butyl phenyl ether, pentyl phenyl ether, methoxytoluene, benzyl ethyl ether, diphenyl ether, dibenzyl ether, o-dimethoxybenzene, 1,2-diethoxyethane, 1,2-dibutoxyethane, diethylene glycol dimethyl ether, diethylene glycol diethyl ether, diethylene glycol dibutyl ether, 1,1-dimethoxymethane, 1,1-diethoxyethane, triethylene glycol dimethyl ether, or tetraethylene glycol dimethyl.

As the halogen substituted compound described above, for example, there is preferably used a fluorinated cyclic carbonate ester, such as fluoroethylene carbonate (FEC), a fluorinated chain carbonate ester, or a fluorinated chain carboxylic acid ester, such as methyl fluoropropionate (FMP).

The electrolyte salt is preferably a lithium salt. As an example of the lithium salt, for example, there may be mentioned LiBF₄, LiClO₄, LiPF₆, LiAsF₆, LiSbF₆, LiAlCl₄, LiSCN, LiCF₃SO₃, LiCF₃CO₂, Li(P(C₂O₄)F₄) LiPF₆₋ₓ(CₙF₂ₙ₊₁)ₓ (1<x<6, n indicates 1 or 2), LiB₁₀Cl₁₀, LiCl, LiBr, LiI, chloroborane lithium, a lower aliphatic carboxylic acid lithium, a boric acid salt, such as Li₂B₄O₇ or Li(B(C₂O₄)F₂), or an imide salt, such as LiN(SO₂CF₃)₂ or LiN(C₂F₂ₗ₊₁SO₂)(CₘF₂ₘ₊₁SO₂) (l and m each indicate an integer of 1 or more). Those lithium salts may be used alone, or at least two types thereof may be used by mixing. Among those salts mentioned above, in view of the ion conductivity, the electrochemical stability, and the like, LiPF₆ is preferably used. The concentration of the lithium salt is preferably set to 0.8 to 1.8 moles per one liter of the nonaqueous solvent.

[Separator]

For the separator, a porous sheet having an ion permeability and an insulating property is used. As a particular example of the porous sheet, for example, fine porous thin film, a woven cloth, and a non-woven cloth may be mentioned. As a material of the separator, an olefin-based resin, such as a polyethylene or a polypropylene, a cellulose, or the like is preferable. The separator may be a laminate containing a cellulose fiber layer and a thermoplastic fiber layer formed of an olefin-based resin or the like.

### EXAMPLES

Hereinafter, although the present disclosure will be further described with reference to Examples, the present disclosure is not limited thereto.

### Example 1

[Formation of Negative Electrode Active Material]

Composite particles (average particle diameter of primary particles of composite particles: 10 μm, average particle diameter of primary particles of Si: 100 nm) formed from Si and Li₂SiO₃ at an equivalent molar ratio were prepared. The Si amount in the composite particle was 42 percent by weight which was obtained by measurement using an ICP (ICP emission analysis apparatus SPS3100, manufactured by SII Nanotechnology Inc.). The average particle diameter of the primary particles was a value obtained by measurement using a particle size distribution meter (particle size distribution measurement apparatus SLAD2000, manufactured by Shimadzu Corporation). According to the result obtained by observation of the cross-section of the composite particle using a SEM, it was confirmed that Si particles were approximately uniformly dispersed in a Li₂SiO₃ phase.

A mixture was formed by mixing 3-aminopropyltriethoxysilane and purified water (mass ratio: 50:50) and was then left for one day, so that a 3-aminopropyltriethoxysilane solution (hereinafter, referred to as “SC solution”) was prepared. The composite particles and the SC solution described above were mixed at a mass ratio of 100:1 and were then dried at 100° C. for approximately 3 hours. The mixture thus obtained was used as a negative electrode active material. According to the result of a Raman spectral analysis of this negative electrode active material using a laser Raman spectroscopic apparatus (ARAMIS, manufactured by HORIBA, Ltd.), it was confirmed that a surface layer containing 3-aminopropyltriethoxysilane was formed on the surface of the composite particle. The content of 3-aminopropyltriethoxysilane with respect to the composite particles was 0.5 percent by mass.

[Formation of Negative Electrode Slurry]

A mixture was formed by mixing graphite, the negative electrode active material obtained as described above, a CMC, and a SBR at a mass ratio of 92.625:4.875:1.5:1.0 and was then diluted with purified water. The mixture thus formed was stirred by a mixer (ROBOMIX, manufactured by PRIMIX Corporation) to form a negative electrode slurry a1. After 8 cc of the negative electrode slurry a1 was sampled and was then injected in an aluminum laminate, the laminate was sealed, so that a slurry sealing body A1 was formed.

### Example 2

Except for that the composite particles and the SC solution were mixed at a mass ratio of 100:2, under the same conditions as those of Example 1, a negative electrode slurry a2 and a slurry sealing body A2 were famed. In the negative electrode active material of Example 2, the content of 3-aminopropyltriethoxysilane with respect to the composite particles was 1 percent by mass.

### Example 3

Except for that the composite particles and the SC solution were mixed at a mass ratio of 100:4, under the same conditions as those of Example 1, a negative electrode slurry a3 and a slurry sealing body A3 were famed. In the negative electrode active material of Example 3, the content of 3-aminopropyltriethoxysilane with respect to the composite particles was 2 percent by mass.

### Example 4

Except for that the type of silane coupling agent was changed to 3-glycidoxypropyltrimethoxysilane, under the same conditions as those of Example 1, a negative electrode slurry a4 and a slurry sealing body A4 were formed. In the negative electrode active material of Example 4, the content of 3-glycidoxypropyltrimethoxysilane with respect to the composite particles in the negative electrode active material was 0.5 percent by mass.

### Example 5

Except for that the type of silane coupling agent was changed to vinyltrimethoxysilane, under the same conditions as those of Example 1, a negative electrode slurry a5 and a slurry sealing body A5 were formed. In the negative electrode active material of Example 5, the content of vinyltrimethoxysilane with respect to the composite particles in the negative electrode active material was 0.5 percent by mass.

### Example 6

Except for that the type of silane coupling agent was changed to 3-methacryloxypropylmethoxysilane, under the same conditions as those of Example 1, a negative electrode slurry a6 and a slurry sealing body A6 were famed. In the negative electrode active material of Example 6, the content of 3-methacryloxypropylmethoxysilane with respect to the composite particles in the negative electrode active material was 0.5 percent by mass.

### Example 7

Except for that the type of silane coupling agent was changed to 3-mercaptopropyltrimethoxysilane, under the same conditions as those of Example 1, a negative electrode slurry a7 and a slurry sealing body A7 were formed. In the negative electrode active material of Example 7, the content of 3-mercaptopropyltrimethoxysilane with respect to the composite particles in the negative electrode active material was 1 percent by mass.

### Comparative Example 1

Except for that the silane coupling agent was not used, under the same conditions as those of Example 1, a negative electrode slurry z and a slurry sealing body Z were famed.

[Gas Generation Test]

Under the following conditions, weight measurement of the sealing body formed as described above was performed, and a gas amount generated from the slurry was measured. The results are shown in Table 1.

[Conditions]

In the state in which the sealing body was hung on a horizontal balance and was entirely dipped in purified water, the weight measurement was performed for four days from the formation of the sealing body. When a gas was generated, the buoyancy generated by the gas was recorded as a minus weight, and the minus weight with respect to Si (mol) was defined as a gas generation amount.

TABLE 1

| | | | | | GAS AMOUNT |
|---|---|---|---|---|---|
| | | | | GAS AMOUNT | AFTER FOUR |
| | SILANE COUPLING TREATMENT | | | AFTER ONE DAY | DAYS |
| | TYPE OF SILANE COUPLING AGENT | CONTENT | | (kg/Si mol) | (kg/Si mol) |
| Z | NONE | — | | 0.850 | 8.354 |
| A1 | 3-AMINOPROPYLTRIETHOXYSILANE | 0.5 | wt % | 0.001 | 0.000 |
| A2 | 3-AMINOPROPYLTRIETHOXYSILANE | 1 | wt % | 0.004 | 0.004 |
| A3 | 3-AMINOPROPYLTRIETHOXYSILANE | 2 | wt % | 0.003 | 0.001 |
| A4 | 3-GLYCIDOXYPROPYLTRIMETHOXYSILANE | 0.5 | wt % | 0.019 | 4.997 |
| A5 | VINYLTRIMETHOXYSILANE | 0.5 | wt % | 0.597 | 5.424 |
| A6 | 3-METHACRYLOXYPROPYLMETHOXYSILANE | 0.5 | wt % | 0.023 | 6.786 |
| A7 | 3-MERCAPTOPROPYLTRIMETHOXYSILANE | 0.5 | wt % | 0.049 | 6.022 |

The sealing bodies A1 to A7 each using the negative electrode active material in which the surface layer containing a silane coupling agent was formed on the surface of the composite particle showed a low gas generation amount as compared to that of the sealing body Z using the negative electrode active material in which the surface layer containing a silane coupling agent was not formed on the surface of the composite particle. In the sealing bodies A1 to A7, it is believed that, for example, since the Si surface was protected by the silane coupling agent, the reaction between Si and water under an alkaline condition could be suppressed. In particular, the sealing bodies A1 to A3 in each of which the surface layer was formed from the silane coupling agent having an amino group showed a low gas generation amount as compared to that of each of the sealing bodies A4 to A7 in each of which the surface layer was famed from the silane coupling agent having an epoxy group, a vinyl group, a methacryl group, or a mercapto group. The reason for this is believed that compared to the silane coupling agent having an epoxy group, a vinyl group, a methacryl group, or a mercapto group, the silane coupling agent having an amino group has a high stability in an alkaline water.

### Example 8

[Formation of Negative Electrode]

The negative electrode slurry a1 famed as described above was applied to two surfaces of copper foil so that the mass of a negative electrode mixture layer per 1 m² was 20 g/m². Next, the negative electrode slurry thus applied was dried at 105° C. in the air and was then rolled to form a negative electrode. In addition, the packing density of the negative electrode mixture layer was set to 1.60 g/ml.

[Preparation of Nonaqueous Electrolyte Liquid]

To a mixed solvent obtained by mixing ethylene carbonate (EC), methyl ethyl carbonate (MEC), and diethyl carbonate (DEC) at a volume ratio of 3:6:1, hexafluoro lithium phosphate (LiPF₆) was added to have a concentration of 1.0 mol/liter, so that a nonaqueous electrolyte liquid was prepared.

[Formation of Positive Electrode]

A mixture was obtained by mixing lithium cobaltate, acetylene black (HS100, manufactured by Denka Company Ltd.), and a poly(vinylidene fluoride) (PVdF) at a weight ratio of 95:2.5:2.5. After N-methyl-2-pyrrolidoen (NMP) as a dispersant was added to the mixture thus obtained, stirring thereof was performed using a mixer (T.K. Hivis Mix, manufactured by PRIMIX Corporation) to prepare a positive electrode slurry. Next, after the positive electrode slurry was applied to two surfaces of a positive electrode collector formed from aluminum foil and was then dried, rolling was performed using a rolling roller machine, so that a positive electrode was famed in which positive electrode mixture layers having a density of 3.60 g/cm³ were famed on the two surfaces of the positive electrode collector.

[Assembly of Battery]

After tabs were fitted to the respective electrodes described above, a wound electrode body was famed by spirally winding the positive electrode and the negative electrode, each of which was provided with the tab, with at least one separator provided therebetween so that the tabs were located at the outermost circumference portion. After the electrode body thus famed was inserted into an exterior package formed from an aluminum laminate sheet having a height of 62 mm and a width of 35 mm and was then vacuum-dried at 105° C. for 2 hours, the nonaqueous electrolyte liquid described above was charged in the exterior package, and an opening portion thereof was sealed, so that a nonaqueous electrolyte secondary battery B1 was formed. A design capacity of this battery was 800 mAh.

### Example 9

Except for that the negative electrode slurry a2 was used, under the same conditions as those of Example 8, a nonaqueous electrolyte secondary battery B2 was formed.

### Example 10

Except for that the negative electrode slurry a3 was used, under the same conditions as those of Example 8, a nonaqueous electrolyte secondary battery B3 was formed.

### Example 11

Except for that the negative electrode slurry a4 was used, under the same conditions as those of Example 8, a nonaqueous electrolyte secondary battery B4 was formed.

### Comparative Example 2

Except for that the negative electrode slurry z was used, under the same conditions as those of Example 8, a nonaqueous electrolyte secondary battery R was famed.

(Charge/Discharge Cycle Characteristics)

By the use of the nonaqueous electrolyte secondary battery described above, a charge/discharge cycle under the following charge/discharge conditions was repeatedly performed 200 times at 25° C.

[Charge/Discharge Conditions]

After a constant current charge was performed at a current of 1.0 It (800 mA) until the battery voltage reached 4.2 V, a constant voltage charge was performed at a voltage of 4.2 V until the current reached 0.05 It (40 mA). After a rest was taken for 10 minutes, a constant current discharge was performed at 1.0 It (800 mA) until the battery voltage reached 2.75 V.

[Capacity Retention Rate after 200 Cycles]

A discharge capacity at the first cycle and a discharge capacity at the 200^{th} cycle under the above charge/discharge conditions were measured, and the capacity retention rate after 200 cycles was obtained by the following formula (1). The results are shown in Table 2.

Capacity Retention Rate After 200 Cycles (%)=(Discharge Capacity at 200^{th} Cycle/Discharge Capacity at First Cycle)×100 (1)

TABLE 2

| | | | | CAPACITY |
|---|---|---|---|---|
| | SILANE COUPLING TREATMENT | | | RETENTION |
| | TYPE OF SILANE | | | RATE AFTER |
| | COUPLING AGENT | CONTENT | | 200 CYCLES |
| R | NONE | — | | 67% |
| B1 | 3-AMINOPROPYL- | 0.5 | wt % | 73% |
| | TRIETHOXYSILANE | | | |
| B2 | 3-AMINOPROPYL- | 1 | wt % | 74% |
| | TRIETHOXYSILANE | | | |
| B3 | 3-AMINOPROPYL- | 2 | wt % | 70% |
| | TRIETHOXYSILANE | | | |
| B4 | 3-GLYCIDOXYPROPYL- | 0.5 | wt % | 69% |
| | TRIMETHOXYSILANE | | | |

The nonaqueous electrolyte secondary batteries B1 to B4 each using the negative electrode active material in which the surface layer containing a silane coupling agent was formed on the surface of the composite particle could suppress the decrease in capacity retention rate in association with charge/discharge cycles as compared to that of the nonaqueous electrolyte secondary battery R using the negative electrode active material in which the surface layer containing a silane coupling agent was not formed on the surface of the composite particle. The reason for this is believed that in the nonaqueous electrolyte secondary batteries B1 to B4, since the Si surface was protected by the silane coupling agent, the reaction between Si and the electrolyte liquid was suppressed, and the decrease in capacity retention rate could be suppressed. In addition, it is believed that in the slurry state for the formation of the electrode, since the reaction between Si and alkaline water was suppressed, and the formation of a new Si surface (newly-formed surface) to be brought into contact with the electrolyte liquid could be suppressed, the reaction between Si and the electrolyte liquid could be suppressed.

### INDUSTRIAL APPLICABILITY

The present invention can be applied to a negative electrode active material for nonaqueous electrolyte secondary batteries and a negative electrode.

### REFERENCE SIGNS LIST

10 negative electrode active material particle
11 lithium silicate phase
12 silicon particle
13 composite particle
14 surface layer

1. A negative electrode active material for nonaqueous electrolyte secondary batteries, the negative electrode active material comprising:
composite particles each containing silicon and a lithium silicate represented by LiₓSiO_{y} (0<x≤4, and 0<y≤4); and
surface layers provided on the surfaces of the composite particles,
wherein the surface layers each contain a silane coupling agent.

2. The negative electrode active material for nonaqueous electrolyte secondary batteries according to claim 1,
wherein the average particle diameter of the silicon is in a range of 1 to 1,000 nm.

3. The negative electrode active material for nonaqueous electrolyte secondary batteries according to claim 1,
wherein the silane coupling agent has an amino group.

4. The negative electrode active material for nonaqueous electrolyte secondary batteries according to claim 1,
wherein the content of the silane coupling agent with respect to the composite particles is in a range of 0.01 to 10 percent by mass.

5. A negative electrode comprising: the negative electrode active material for nonaqueous electrolyte secondary batteries according to claim 1.
